(19) United States
(12) Patent Application Publication
(10) Pub. No.: US 2026/0135769 A1
(43) Pub. Date: May 14, 2026

(54) Traffic Modeling Network Application Services

(71) Applicant: eBay Inc., San Jose, CA (US)

(72) Inventors: Linhai Jiang, Shanghai (CN); Yogesh Yashwant Patil, Davis, CA (US); Zhongping Wang, Shanghai (CN)

(73) Assignee: eBay Inc., San Jose, CA (US)

(21) Appl. No.: 18/948,165

(22) Filed: Nov. 14, 2024

(51) Int. Cl. H04L 41/14

(52) U.S. Cl. CPC H04L 41/145

(57) ABSTRACT

Traffic modeling network application services is described. An example system includes a network traffic model that defines traffic relationships for data traffic in a network between a network topology of an application and a plurality of different access points serving network connections through different physical or logical tiers of the network topology with at least one instance of the application based in part on domain-subdomain relationships obtained from a domain name system record model for communicating on the network. A first access point in the system, in response to receiving a first communication between a first endpoint and a first instance of the application, serves the first communication on a first network connection through a first tier of the network topology with the first instance of the application based on a first traffic relationship defined by the network traffic model for the first network connection.

### BACKGROUND

Computing devices use network infrastructures to exchange data between endpoints, such as devices, applications, and services. Network applications form application endpoints that offer various services through network connections with other endpoints. These applications improve performance, robustness, and security by integrating multiple network technologies. Access points are distributed throughout a network to connect application and client endpoints through application-specific network topologies. Efficiently deploying network application services through access points and complex network topologies is challenging. Performance issues arise when the interactions between a network topology and an underlying network application are not well understood or accounted for in an application's network architecture.

### SUMMARY

Techniques are described for traffic modeling network application services. Domains and subdomains associated with a network address accessible by computing devices, applications, and so forth, implement methods, systems, computer-readable storage media, and combinations thereof to model data traffic flows in network topologies that deliver services from network applications. The traffic modeling techniques streamline the deployment of network applications and management of communications distributed by access points through different tiers of a network topology linking the network applications to that network address.

A traffic management system generates a network traffic model that defines network data traffic flows between access points and instances of an application executing on the network. The network traffic model establishes a traffic relationship between a network topology of the application, and an access point serving network connections with the application through different tiers of the network topology. The access point uses the traffic relationship output from the network traffic model to establish secure and efficient communication channels with the application through each of the different tiers. The traffic relationship describes information for managing communications with the application, including for complying with communication rules and protocols specified for each network topology tier. In at least one example, the network traffic model automatically interfaces with other network models and network traffic management technologies to bolster the information included in the traffic relationships.

Adapting each access point to rely on network traffic models when processing data traffic of network applications improves performance and reduces complexity when managing communications served between endpoints and network application services. When implemented by access points, the traffic relationships enhance operational efficiency of network application services, including for enabling network automation. Traffic relationships defined by the network traffic model are usable (e.g., from a user interface to the model) to abstract various intricacies of each logical or physical tier of the network topology that connects an application interface to the network. The traffic relationships output from the network traffic model expose interplays between aspects of the network topology and the network technology used to form each application interface. These mixed model relationships are partially captured by user defined parameters and instructions for provisioning the traffic interfaces, e.g., to implement various application tasks. Deficiencies in the user definitions of the traffic interfaces are addressed by network models and by distributing access point data associated with the relationships. The interplay exposure facilitates network application development and design to adapt implementations of application services for different layers of an application network topology.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In some implementations, entities represented in the figures are indicative of one or more entities and thus reference is made interchangeably to single or plural forms of the entities in the discussion.

FIG. 1 is an illustration of an environment in an example implementation that is operable to employ a traffic management system that models traffic for network application services.

FIG. 2 depicts an example implementation that is operable as a traffic management system that models traffic relationships for delivering network application services.

FIG. 3 depicts an example of a graph of traffic relationship data used by the traffic management system of FIG. 1 to generate traffic relationships for network connections between an access point and application instances.

FIG. 4 depicts an example of a network traffic model used by the traffic management system of FIG. 1 to generate traffic relationships for network connection between access points and application instances.

FIG. 5 is an illustration of an environment in an example implementation that is operable to employ a traffic management system that models traffic for network application services supported through execution of multiple applications.

FIG. 6 is a flow diagram depicting a procedure in an example implementation in which a traffic relationship is defined by a traffic management system to control data communication via a network connection between an access point and application endpoint.

FIG. 7 illustrates an example system including various components of an example device to implement the techniques described with reference to FIGS. 1-6.

### DETAILED DESCRIPTION

### Overview

Computing devices utilize network infrastructures to exchange data between endpoints, such as devices, applications, and services, based on data traffic communicated through a network. Example endpoints include client applications executing on client devices and network applications executing on server devices.

Network applications spawn application endpoints, which supply various services through network connections established with other endpoints. Network applications enhance performance, robustness, and security by integrating multiple network technologies, such as caching, load balancing, Points of Presence (POP), Content Delivery Networks (CDNs), and Domain Name Service (DNS) layering. In a conventional network infrastructure, such as an enterprise network or domain, application services are supported by thousands of individual application endpoints executing concurrently within the network or domain.

Each application instance potentially supports a specific purpose or manages a particular traffic load for each client endpoint being served. Multiple application endpoints can originate from the same network application to enable concurrent access by multiple individual clients. Application endpoints exchange communications with client endpoints using communication channels enabled by access points.

Access points are distributed throughout the network or domain and assigned physical or virtual network locations to connect application and client endpoints through an application network topology accessible from that network location. The access points manage the communications exchanged through physical or logical tiers of the network topology by adhering to specific routing rules adopted by the tiers.

Establishing a connection from an access point by mapping the multiple technology layers of an application endpoint to the various tiers of a complex network topology is difficult. Network application developers may not grasp the nuances of a network infrastructure to deploy sophisticated network applications that consistently achieve a high degree of reliability and performance using multiple levels of network technology. Without a detailed appreciation for the complexities of a network service environment, application developers and network administrators struggle to configure network applications and access points to serve communications correctly and efficiently towards achieving performance and security metrics set for the environment.

To help application developers, administrators, and other users deploy network services through access points that connect multiple application technology layers to complex network topologies, a traffic management system is described including a network traffic model. The network traffic model defines traffic relationships between a network topology of an application, and a plurality of different access points serving communications through different tiers of the network topology, including to different technology layers of the application.

The traffic relationships defined by the network traffic model are usable by application developers and network administrators (e.g., through access to a user interface with the model) to abstract various intricacies of each logical or physical tier of the network topology that connects an application interface to the network. The traffic relationships expose interplays between aspects of the network topology and the network technology used to form each application interface on the network, and are usable by network devices (e.g., access points) to implement application tasks. The interplay exposure facilitates network application development and design to adapt implementations of application services for different layers of an application network topology. In at least one example, these mixed model relationships are partially described by user inputs (e.g., to define parameters and instructions for provisioning the traffic interfaces). The network traffic model outputs access point data and other traffic relationship information to address deficiencies of the user inputs.

As one example, the traffic relationships output from the network traffic model indicate traffic management schemes applied by access points that are serving communications related to the application services. Each access point manages the communications served between endpoints based on the traffic relationships. An access point, for example, transmits communications from a client endpoint to an application endpoint using routing rules defined by the traffic relationship. Adherence to the routing rules, for instance, establishes an efficient, robust, and secure network connection through a particular physical or logical tier of the network topology.

In operation, a first access point distributed among the plurality of access points in the network is configured to manage communications between a first endpoint (e.g., a client application executing inside or outside the domain) and a first instance of a network application. The first access point serves communications on a first network connection through a first tier of the network topology with the first application instance based on a first traffic relationship defined by the network traffic model for the first connection. In variations, the different tiers each adopt different corresponding routing rules, and the first traffic relationship includes first routing rules defined by the network traffic model for a first tier.

In response to receiving a first communication between the first endpoint and the first instance of the application, the first access point serves the first communication on the first network connection. The first communication is served through the first tier of the network topology with the first application instance based on the first traffic relationship defined by the network traffic model for the first connection. The first access point, for instance, uses the first routing rules to serve the first communication between the first endpoint and the first application instance.

To bolster the information included in the traffic relationships, the network traffic model automatically interfaces with other network models, such as domain name service and security models. The traffic relationship modeling is plug-and-play compatible with other network models to improve the definitions of the traffic relationships. The traffic network model enhances the traffic relationships based on domain-subdomain relationships obtained from a domain name system record model, certificate relationships obtained from a domain name system secure access point model, or combination of relationships and information obtained from these and other network models and traffic analysis and management technologies.

In this manner, the traffic relationships output from the network traffic model are usable for adapting access point functionality to different logical or physical tiers of the specific network topology used to implement an application network interface. Adapting each access point to rely on the network traffic model improves performance and reduces complexity involved with managing communications between endpoints and application instances. Traffic relationships abstract various intricacies of each logical or physical tier of the network topology that connects an application interface to the network. With this abstraction, the traffic relationships output from the network traffic model expose interplays between the different tiers of the network topology and each layer of the network technology used to implement an application network interface.

Modeling data traffic flows using the network traffic model facilitates network infrastructure level design, and network application development. From using the network traffic model, application developers gain insights into various network layers that form connections to the applications for modifying the network applications to improve performance and efficiency. When used by access points, the traffic relationships enhance operational efficiency of network application services, including for enabling network automation. The traffic relationship modeling is plug-and-play compatible with other network models to improve the definitions of the traffic relationships. The data traffic modeling enables seamless integrations with other network modeling systems and techniques to further improve performance, including to support network automation.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

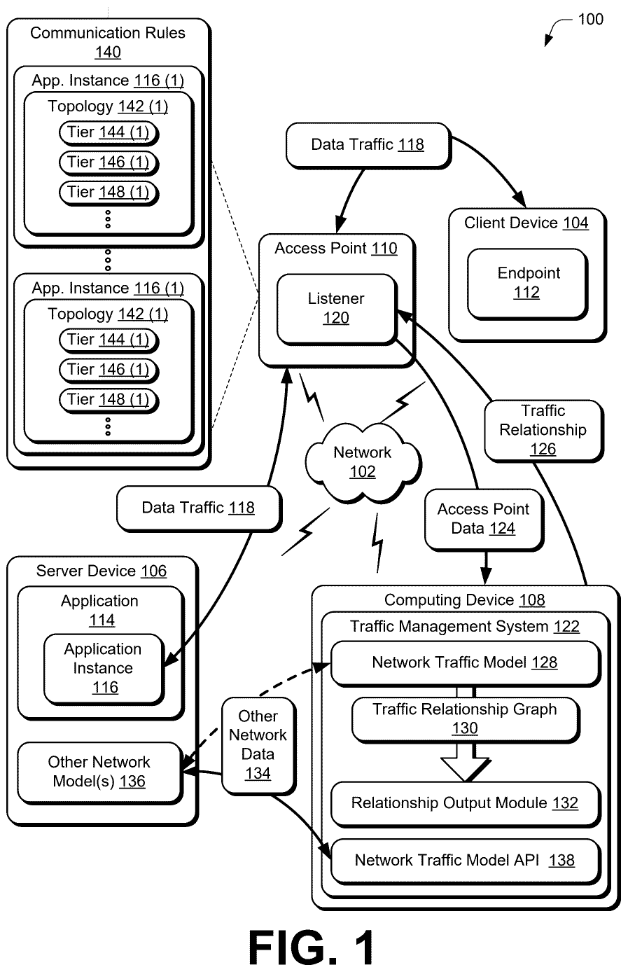

FIG. 1 is an illustration of a digital medium environment 100 in an example implementation that is operable to employ techniques described herein. As used herein, the term “digital medium environment” refers to the various computing devices and resources utilized to implement the techniques described herein. The digital medium environment 100 includes a network 102 that communicatively couples a client device 104, a server device 106, a computing device 108, and an access point 110 to exchange data in the environment 100. The client device 104, the server device 106, the computing device 108, and the access point 110, which are also referred to as computing devices or computing systems, are each configurable in a variety of manners.

A computing device, for instance, is configurable as a desktop computer, a laptop computer, a mobile device (e.g., assuming a handheld or wearable configuration such as a tablet or mobile phone), and so forth. Thus, a computing device ranges from full-resource devices with substantial memory and processor resources (e.g., personal computers, game consoles) to low-resource devices with limited memory and/or processing resources (e.g., mobile devices). Additionally, although described in the context of a single computing device, a computing system is representative of a plurality of different devices, such as multiple servers and equipment utilized to perform operations “over the cloud.”

In the illustrated example, the client device 104 includes an endpoint 112 communicating on the network 102, which is configured as a destination or source for data traffic 118 transmitted through the network 102. The endpoint 112, for instance, is a client application that relies on one or more applications services executed by the server device 106.

The server device 106 includes an application 114 (e.g., a network application), which when executed, invokes an application instance 116 communicating on the network 102. The application instance 116 (or the application 114) implements one or more services on behalf of the endpoint 112 based on communications exchanged over the network 102 between the endpoint 112 and the application instance 116. The application instance 116 represents an application endpoint, which like the endpoint 112, is configured as a destination or source for the data traffic 118 transmitted through the network 102. The application instance 116, for example, is a server application that executes on the server device 106 to support network application services supplied to the network 102. The network application services executed by the server device 106 are accessed from other endpoints on the network 102, including the endpoint 112.

Consider a scenario where a user of the client device 104 wishes to check an account balance on payday. The user interacts with a mobile application, which when executing on the client device 104 is configured as the endpoint 112. The endpoint 112 accesses public-facing account services managed by a banking application, which in this example is configured as the application 114 when executing on the server device 106. To enable concurrent access to the customer facing account services from multiple endpoints, or to provide different entry points into the application 114, the server device 106 executes one or multiple instances of the application 114. The application instance 116 implements the public-facing account services, which are accessed through the network 102 by the endpoint 112. The application instance 116 and the endpoint 112 communicate the data traffic 118, which includes user/device credentials, encrypted banking information, and so on, back, and forth through the network 102. Through this communication, the endpoint 112 is operable to update the account balance presented through the mobile application to indicate a current balance that reflects a recent paycheck deposit. This scenario represents an example implementation where the application 114 executes within a domain (e.g., a bank application service environment), and the endpoint 112 accesses the application 114 from an external connection with the domain, such as from a second application (e.g., the mobile application) executing outside the domain.

In another scenario, the application 114 and the endpoint 112 both execute within the same domain. The application 114 is a first application within the domain, and the endpoint 112 includes a second application executing inside the domain. The client device 104 in this scenario is a bank terminal executing the endpoint 112 from the same domain as the banking application implemented by the application instance 116 of the application 114. A bank employee accesses the client device 104 to audit and generate reports based on multiple client accounts (e.g., for different branches). The user interacts with a desktop application configured as the endpoint 112 to access the application 114 and the private account services of the banking application supported by the application instance 116. The application instance 116 and the endpoint 112 communicate the data traffic 118 to produce information used to perform the audits and generate the reports.

In a third scenario, the application 114 and the endpoint 112 both execute within the same domain, however, the client device 104 belongs to a network administrator or application developer responsible for reconfiguring, adjusting, or modifying the application 114. Rather than access the public-facing or private banking services implemented by the application instance 116, a user of the client device 104 connects to one or more backend or administrator type interfaces of the application 114. The administrator interfaces, for instance, enable entry into different technology levels or topology tiers of the application instance 116, such as to debug, reprogram, or otherwise interact with the backend functions implemented by the application 114.

In each of the scenarios outlined above, the application 114 and the endpoint 112 are operable to communicate application-to-application without supervision from a user. The endpoint 112 is a third-party application, for instance, used to centrally manage financial accounts from multiple institutions. Occasionally, the endpoint 112 interfaces with the application instance 116 to exchange the data traffic 118 for updating information associated with a financial account being managed from the endpoint 112.

As described herein, the access point 110 refers to a location where an exchange of data takes place. For example, the access point 110 manages an exchange of the data traffic 118 being transmitted through the network 102 between the endpoint 112 and the application instance 116. In day-to-day operations of the environment 100, the access point 110 represents one of a plurality of access points (e.g., tens, hundreds, thousands) distributed throughout the network 102. The access point 110 individually manages the data traffic 118 exchanged with the application instance 116 during implementation of the application services. The access point 110 serves communications based on the data traffic 118 between the application instance 116 and the endpoint 112 when the endpoint 112 uses the services supported by the application instance 116.

In the context of Internet Service Providers (ISPs), the access point 110 is representative of a public exchange facility where ISPs can connect with one another to allow exchange of traffic between different ISP networks, thus enabling data from one ISP's clients to reach clients on another ISP's network. Access points are a part of network infrastructures and include physical locations (e.g., data centers) where different networks, services, and devices are connected to one another via routers, switches, and so forth. In the context of wireless network communications, telecommunications, and so forth, the access point 110 is representative of a device such as a router or a hub that provides connectivity for devices to the network 102.

In some implementations, the access point 110 is associated with a network address, such as an IP address, a virtual IP address, and so forth, thus representing a device that provides connectivity between different endpoints (e.g., different devices) for data communication. For instance, in implementations where the access point 110 represents a virtual IP address, the access point 110 is a virtual IP (VIP) access point accessible by one or more physical network interfaces, one or more devices, or combinations thereof. In some examples, an IP address is assigned to multiple servers or network devices across different locations. An IP address assigned to multiple servers or network devices across different locations may be referred to as an anycast IP address, or in the case of a virtual IP address, an anycast virtual IP address. For anycast IP addresses, incoming data traffic is distributed across multiple access points 110, which improves load distribution and prevents overload at individual access points 110. Additionally, or alternatively, distributing incoming data traffic across multiple access points 110 provides redundancy for directing traffic to available access points 110, which may result in improved network latency and overall responsiveness of services for the traffic management system 122.

The access point 110 is an unsecure access point in at least one implementation and is a secure access point in at least one other implementation. As a secure access point, the access point 110 maintains secure connections through the network 102 a secure protocol such as HTTPS (e.g., HTTP over TLS/SSL), which initiates a security handshake between the access point 110 and an endpoint, such as the endpoint 112 or the application instance 116. For instance, the access point 110 receives the data traffic 118 from the endpoint 112. The data traffic 118 triggers a TLS handshake, which is a known process by which the client device 104 and the access point 110 establish a secure encrypted connection. As part of the TLS handshake, the access point 110 sends a certificate to the client device 104. The client device 104 then validates the certificate using known certificate validation techniques, such as by checking the expiration date of the certificate to ensure validity, by performing a chain of trust verification to ensure that the signature of a trusted authority is valid using a public key of the trusted authority, performing hostname verification with the access point 110, and so forth.

The access point 110 includes a listener 120 that is communicatively coupled to a traffic management system 122 implemented by the computing device 108. The listener 120 is representative of a component of the access point 110 that identifies access point data 124 that is used to define a traffic relationship 126 between the access point 110 and a domain or subdomain of the network 102, an endpoint on the network 102, such as the client device 104, the server device 106, the endpoint 112, and the application instance 116, an origin server, a proxy, or combinations thereof. For instance, the access point data 124 indicates that the data traffic 118 received from the endpoint 112 is to be routed via the access point 110 to the application instance 116.

The access point data 124 in one or more implementations includes routing metrics related to a data load in the data traffic 118 communicated to an endpoint destination, a geographic location of the endpoint destination, a traffic speed at the endpoint destination, among other factors and/or metrics. The access point data 124 in aspects includes a network address, a sub-domain or a domain name, and other information inferred from the data traffic 118 about the endpoint 112 and the client device 104, and the server device 106 and the application instance 116.

The access point 110 performs a variety of operations and tasks to manage and facilitate the data traffic 118 between the endpoint 112 and the application instance 116. Execution of the operations and tasks facilitate the generation of the access point data 124, which is used to improve performance and reliability of access point tasks.

As one example, traffic management operations and tasks performed at the access point 110 to implement load balancing and quality of service (QoS) functions. The load balancing improves the data traffic 118 distribution to occur evenly at the access point 110 and other access points to prevent the access point 110 from becoming overloaded processing too much of the data traffic 118. QoS enables the access point 110 to prioritize various types of traffic to support high performance and minimal latency. The access point data 124 includes information used in the traffic management operations and tasks.

As another example of access point tasks, security operations are implemented by the access point 110. This includes performing authentication processes to verify the identity of device endpoints (e.g., the client device 104) and the endpoint 112 and/or users attempting to connect to the network 102 using protocols like WPA3 or 802.1X. Encryption processes are implemented by the access point 110 to secure the transmissions of data traffic 118 and communications served from the access point 110 with encryption standards, such as the Advanced Encryption Standard (AES), to protect against eavesdropping and data breaches. Intrusion Detection and Prevention are performed as part of security operations to monitor the data traffic 118 for suspicious activity and taking action to block potential threats to the application instance from unauthorized endpoints. Information used to implement the security operations is included in the access point data 124, in one or more examples.

Network optimization, client management, monitoring analysis, and configuration management are additional example operations implemented by the access point 110 to ensure that the data traffic 118 is efficiently managed, secure, and optimized for performance across the network 102. In various implementations, information used to implement the network optimization, client management, monitoring analysis, and configuration management operations is included in the access point data 124.

Network optimization includes executing operations from the access point 110 to perform channel management and signal strength adjustment. Network optimization automatically serves communications from the access point 110 over communications channels selected to minimize interference and maximize performance. Signal strength adjustment dynamically modifies power levels of signals transmitted from the access point 110 to satisfy expected coverage metrics and reduce interference.

Client management performed by the access point 110 includes executing operations that enable roaming support and client isolation. Roaming support enables seamless transitions when the client device 104 and the endpoint 112 migrate to different access points (e.g., when the endpoint 112 is a mobile application and the client device 104 is a mobile device moving between different access points at various geographic locations without dropping a connection with the application instance 116. The access point 110 implements client management tasks to perform client isolation, which enhances security by preventing direct communication between two or more of the client devices 104 that are connected to the network 102

As another example of access point tasks, monitoring and analysis operations are implemented by the access point 110. This includes performing monitoring of the data traffic 118 to continuously track the performance of the network 102 and the connected devices (e.g., the client device 104, the server device 106). Performance tracking enables the access point 110 to proactively identify and resolve performance issues. The monitoring and analysis operations also include usage analysis. The access point 110 generates usage analytics based on the data traffic 118 and network usage patterns derived from the performance monitoring. Based on the usage analytics, the access point 110 optimizes resource allocation and implements plans to accommodate future capacity demands.

Configuration management performed by the access point 110 includes supporting remote management at the access point 110 to allow network administrators and other applications with sufficient permissions, to configure and manage the access point 110 remotely, such as through a centralized controller or cloud-based platform in communication with the network 102. Configuration management tasks of the access point 110 in at least one implementation include managing firmware or other software updates to the access point 110 for ensuring operations rely on the latest features and security patches.

In implementations, the listener 120 is configured as a software component or a service of the access point 110 that monitors and processes incoming network connections and communication requests at the access point 110, for instance, to execute the operations and tasks that derive the access point data 124. Alternatively or additionally, despite being depicted in the illustrated example of FIG. 1 as being implemented at the access point 110, the listener 120 is implemented remotely from the access point 110. The listener 120 is further representative of functionality to manage connections between endpoints and the network 102 based on a traffic relationship 126 defined from the access point data 124 obtained from the access point 110. Alternatively or additionally, the listener 120 operates as a security mechanism to block or restrict unauthorized connections based in part on the traffic relationship 126, such as connections that are not explicitly permitted by routing rules, a certificate, or other information used from the access point data 124 to describe the traffic relationship 126.

The traffic management system 122 is representative of functionality of the computing device 108 that receives the access point data 124 from the access point 110 and returns at least one traffic relationship 126 that is based at least partially on the access point data 124. The traffic management system 122 obtains the access point data 124 identified by the listener 120 from monitoring the data traffic 118. Then, to facilitate the data traffic 118 being served by the access point 110, the traffic management system 122 executes a network traffic model 128 to define the traffic relationship 126 based on the access point data 124.

The network traffic model 128 defines the traffic relationship 126 applied by the access point 110 to achieve operational functionality of application services implemented at each technology layer of the application instance 116. A conventional access point is limited to directing data traffic associated with a single application layer. In contrast to conventional access points, the access point 110 uses information output from the network traffic model 128, including the traffic relationship 126. The traffic relationship 126, for instance, describes how to direct the data traffic 118 between the endpoint 112 and each technology layer of the application instance 116. As another example, the traffic relationship 126 specifies a protocol for serving communications through each tier of a network topology linking the network 102 to the application instance 116, which is impacted by the data traffic 118.

The traffic relationship 126 exposes one or more interplays between aspects of the network topology and the network technology used to form each application interface on the network 102. The interplay exposure facilitates network application development and network traffic management of the network 102 to adapt implementations of application services for different layers of an application network topology. In at least one implementation, the access point 110 applies the traffic relationship 126 to automatically serve the data traffic 118 through a tier of the network topology using an appropriate protocol defined for that tier. The traffic relationship 126 is usable by the access point 110, for example, to implement application tasks of the application 114. In at least one example, the traffic relationship 126 is further usable by application developers and network administrators (e.g., through access to a user interface with the network traffic model 128) to abstract various intricacies of each logical or physical tier of the network topology that connects an interface (e.g., the application instance 116) of the application 114 to the network 102.

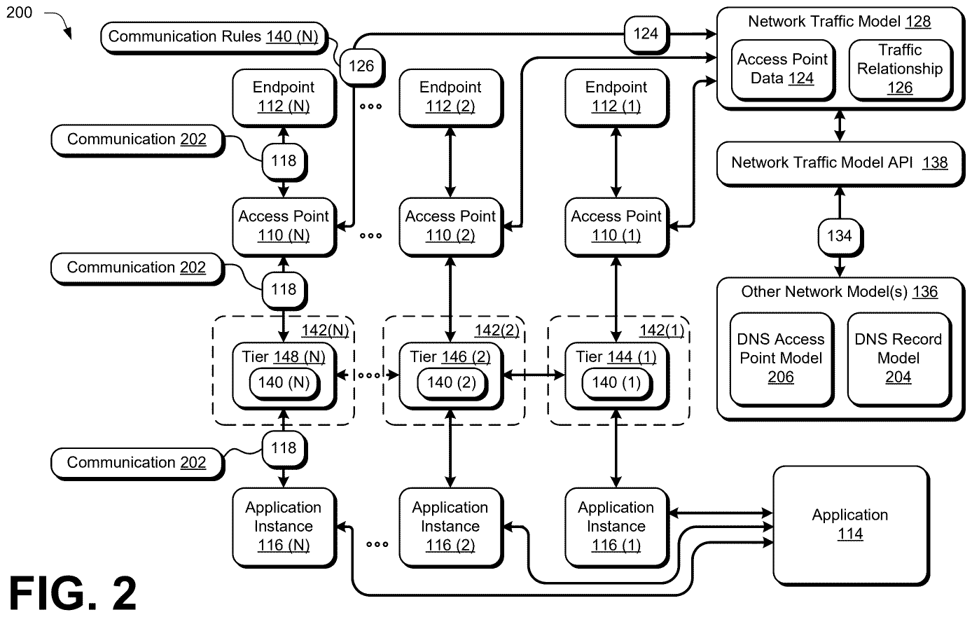

In at least one example, the traffic relationship 126 are at least partially described based on user defined parameters and instructions for provisioning the access point 110 and/or the application instance 116 on the network 102. The network traffic model 128 outputs additional information to complete the traffic relationship 126 and describe areas of the provisioning that are undefined by the user inputs. For additional details of the network traffic model 128, and implementations for improving deployment of network application services, consider the examples depicted in FIGS. 2 through 5.

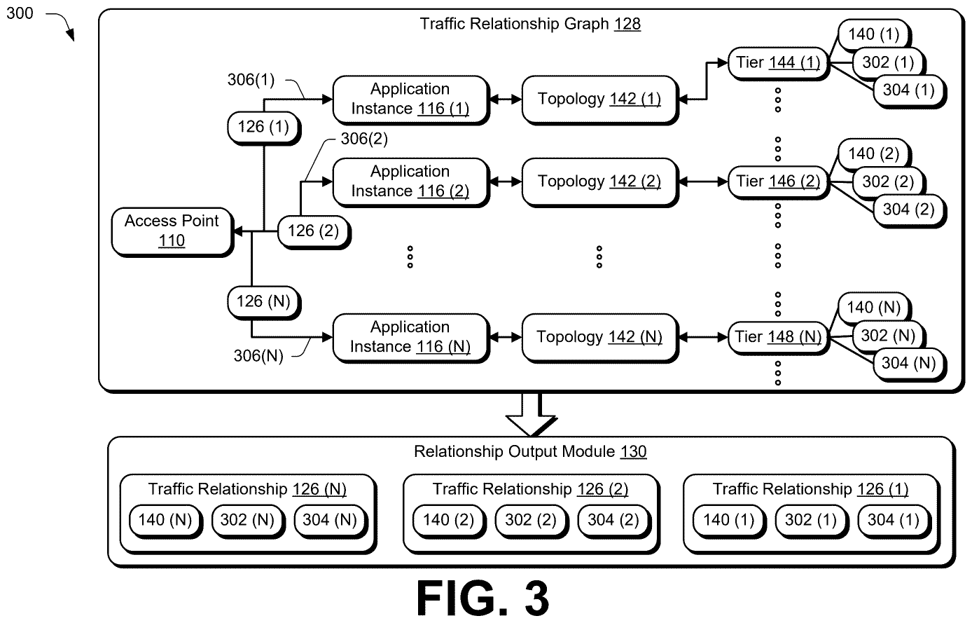

In at least one example, the network traffic model 128 uses a graph structure to model each traffic relationship defined for the application 114 and/or the application instance 116. A traffic relationship graph 130 represents each access point 110 and each application instance 116 assigned to the application 114, as a different corresponding node in the traffic relationship graph 130. Network connections formed between the access points and application instances are represented by paths in the traffic relationship graph 130 between a corresponding pair of communicating nodes. The traffic relationship graph 130 includes one or more paths connecting the access point 110 to the different tiers of the network topology of each application instance 116. For an example of the traffic relationship graph 130, consider FIG. 3.

The network traffic model 128 enables automation and wider adoption of various network application services and other network models. For example, the network traffic model 128 shares an interface that receives other network data 134 from other network models 136 executing on the server device 106 (or another endpoint in the network). The other network data 134 is usable by the network traffic model 128 to bolster the traffic relationship 126 provided to the access point 110. The interface shared between the other network models 136 and the network traffic model 128 is implemented, in one or more implementations, as an application program interface (API) labeled in FIG. 1 as a network traffic model API 138. The network traffic model API 138 defines the fields of the interface for sending or receiving data to and from the network traffic model 128.

To enhance the information included in the traffic relationship 126, the network traffic model 128 automatically interfaces with the other network models 136, such as domain name service and security models. The network traffic model API 138 enables the network traffic model 128 to be plug-and-play compatible with the other network models 136 to improve the description of the traffic relationship 126. For example, the network traffic model 128 enhances the traffic relationships based on domain-subdomain relationships obtained from the other network data 134 received from a domain name system record model, certificate relationships obtained from the other network data 134 received from a domain name system secure access point model, or combination the other network data 134 received from these and the other network models 136 and/or traffic analysis and management technologies deployed on the network 102.

Based on the access point data 124, the relationship output model 132 outputs the traffic relationship 126 derived from the information contained in the paths of the traffic relationship graph 130. The listener 120, for instance, receives the traffic relationship 126 communicated from the relationship module 132.

The traffic relationship 126 includes information for automatically configuring the access point 110 to serve communications derived from the data traffic 118 by complying with routing rules, protocols, security checks, and other parameters or specifications of the endpoint 112 and the application instance 116. For example, the access point 110 determines communication rules 140 based on the traffic relationship 126. The communication rules 140 are depicted in the example of FIG. 1 as being organized according to each application instance 116) that is accessible from the access point 110, including application instances 116(1) through 116(N), where N is any integer.

For each application instance 116, the communication rules 140 are further organized according to different tiers of a network topology 142 delineated by one or more communication tiers that serve communications through that topology 142. The access point 110 derives the communication rules 140 associated with the application instance 116(1) based on the traffic relationship 126 received for that connection. The communication rules 140 specify how communications are to occur when communicating through each of a first tier 144(1), a second tier 146(1), and a third tier 148(1) of the network topology 142(1). The access point 110 derives the communication rules 140 associated with the application instance 116(N) based on the traffic relationship 126 received for that connection. The communication rules 140 specify how communications are to occur when communicating through each of a first tier 144(N), a second tier 146(N), and a third tier 148(N) of the network topology 142(N). The access point 110 is automatically configured based on the traffic relationship 126 received from the network traffic model 128, improving performance and efficiency of managing the data traffic 118 exchanged between the endpoint 112 and the application instance 116.

Through implementation of the network traffic model 128, user intentions are partially captured by the traffic relationship 126 to provision the traffic interfaces. In various aspects, the user intentions are deficient and the provisioning information of the traffic relationship 126 is incomplete. The network traffic model 128 uses the access point data 124 and/or the other network data 124 to finish the description of the traffic relationship 126, and perform various automation and visualization (e.g., of the traffic relationship graph 130) based on the data traffic 118.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the combinations represented by the enumerated examples in this description.

### Example Traffic Modeling Network Application Service Techniques

The following discussion describes multiple agent automatic root cause analysis techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. For ease of description, the techniques are described with reference back to the environment 100 of FIG. 1.

FIG. 2 depicts an example implementation 200 that enables the traffic management system 122 to model traffic relationships between access points and endpoints for network application services. The implementation 200 includes a plurality of access points 110(1) through 110(N), with each being an example of the access point 110. Each of the access points 110(1) through 110(N) serves communications 202 derived from the data traffic 118 exchanged between different example pairs of the endpoint 112 and the application instance 116. Each different endpoint and application instance pair includes one of endpoints 112(1) through 112(N) and one of application instances 116(1) through 116(N). A corresponding network topology 142(1) through 142(N) is used to establish a network connection (e.g., communication channel) with each endpoint and application instance pair.

Each of the access points 110(1) through 110(N) serves the communications 202 between a corresponding pair of the endpoints 112(1) through 112(N) and the application instances 116(N). An endpoint 112(1) communicates with an application instance 116(1) of the application 114 through the access point 110(1) and a network connection established through the network topology 142(1). An endpoint 112(2) communicates with an application instance 116(2) of the application 114 through the access point 110(2) and a network connection established through a network topology 142(2). An endpoint 112(N) communicates with an application instance 116(N) of the application 114 through the access point 110(N) and a network connection established through the network topology 142(N).

A network connection established through each of the network topologies 142(1) through 142(N) adheres to communication protocols and rules for communication channels established through specific topology tiers. The access point 110(1) serves the communications 202 through the network topology 142(1) by adhering to communication rules 140(1) associated with the tier 144(1). The access point 110(2) serves the communications 202 through the network topology 142(2) by adhering to communication rules 140(2) associated with the tier 146(2). The access point 110(N) serves the communications 202 through the network topology 142(N) by adhering to communication rules 140(N) associated with the tier 148(N).

The network traffic model 128 has a corresponding access point interface with each of the access points 110(1) through 110(N). The network traffic model 128 obtains respective access point data 124 from each of the access points 110(1) through 110(N) using the corresponding access point interface, and in return, outputs a respective traffic relationship 126 for each of the access points 110(1) through 110(N) using the corresponding access point interface.

With the access point data 124 obtained from each of the access points 110(1) through 110(N), the network traffic model 128 defines the traffic relationship 126 between each of the network topologies 142(1) through 142(N) and the application instances 116(1) through 116(N). The traffic relationship 126 defined for the network topology 124(1) includes the communication rules 140(1) and an indication that the tier 144(1) is an application gateway layer. The traffic relationship 126 defined for the network topology 124(2) includes the communication rules 140(2) and an indication that the tier 146(2) a data cluster gateway layer. The traffic relationship 126 defined for the network topology 124(N) includes the communication rules 140(N) and an indication that the tier 148(N) is a point of presence layer. Other types of network technology layering is used in other implementations of the application instances 116(1) through 116(N). For example, a caching tier, a Content Delivery Network tier, and a domain name service tier are other types of tiers integrated through network application technology layering.

As depicted in FIG. 2, the network traffic model 128 enables automation and integrates with various other network application services, including other network models used to manage the network 102. For example, the network traffic model 128 seamlessly integrates with a domain name system record model 204, which derives domain-subdomain relationships for communicating on the network 102. For example, the tier 148(N) enables an entry point into a specific subdomain of the network 102 where the application instance 116(N) is executing to provide application services. From the domain name system record model 204, the network traffic model 128 obtains the domain-subdomain relationship for communicating within the tier 148(N) of the network topology 142(N). The other network data 134 describes the domain-subdomain relationship and is input to the network traffic model API 138, from which the domain-subdomain relationship information is included in the traffic relationship 126 defined for that connection.

As another example, the network traffic model 128 is plug-and-play compatible with a domain name system access point model 206. The network traffic model 128 seamlessly integrates with the domain name system access point model 206 to derive certificate relationships for securely communicating on the network 102. For example, the access point 110(N) serves the communications 202 securely through the network topology 142(N) by managing a security handshake between the endpoint 112(N) and the application instance 116(N). The security handshake is based on certificate relationship (e.g., a certificate) obtained from the domain name system access point model 206 for the tier 148. The certificate relationship is based on the domain-subdomain relationship obtained from the domain name system record model 204. The network traffic model 128 obtains the certificate relationship for communicating securely through the tier 148 between the endpoint 112(N) and the application instance 116(N). The other network data 134 includes the certificate relationship when input to the network traffic model API 138. The network traffic model 128 includes the certificate relationship within the traffic relationship 126 defined for that connection. The certificate relationships are useable by the network traffic model 128 to solve various issues that arise with establishing secure interfaces, such as public and private connections between the endpoint 112(N) and a domain of the application instance 116(N), including interfaces that are internal or external to the domain. The certificate relationships enable the access point 110(N) to implement robust, public, or private interfaces or communication channels of the application instance 116(N), with heightened security.

FIG. 3 depicts an example 300 of a traffic relationship graph 130 used by the traffic management system 122 to generate the traffic relationships 126(1) through 126(N) for multiple network connections established between the access point 110 and the application instances 116(1) through 116(N). The access point 110 is represented as a node in the traffic relationship graph 130 that is linked to other nodes in the traffic relationship graph 130 that correspond to different application instances 116(1) through 116(N) served by the access point 110. For example, a path 306(1) in the traffic relationship graph 130 connects the access point 110 to the application instance 116(1). Following the path 306(1) through the traffic relationship graph 130 produces the communication rules 140(1), a certificate relationship 302(1), and a domain record 304(1) that the network traffic model 128 uses to build the traffic relationship 126(1). The communication rules 140(1) in one or more examples include routing rules adopted by each tier of the network topology 142(1), including the tier 144(1), the tier 146(1), the tier 148(1), and so forth. Bolstering the traffic relationship 126(1) to include additional information aids the access point 110 in handling future service requests from endpoints accessing different layers or tiers of the application instance 116(1) than a currently being accessed tier.

Following the path 306(2) and the path 306(N) through the traffic relationship graph 130 similarly produces the information from the traffic relationship graph 130 used by the network traffic model 128 to build the traffic relationship 126(2) and 126(N), respectively.

Consider a scenario where the tier 144(1) is a point of presence tier in the network topology 142(1), the tier 146(2) is a data center gateway tier in the network topology 142(2), and the tier 148(N) is an application gateway tier in the network topology 142(N).

The traffic relationship 126(1) includes information to enable the access point 110 to establish a network connection through the tier 144(1) for supporting a public facing, connection to the application instance 116(1). For example, the tier 144(1) provides an initial entry point for external traffic into the domain of the application instance 116(1). From the tier 144(1), the endpoint 112 and the application instance 116(1) filter and inspect the data traffic 118. The access point 110 performs deep packet inspection (DPI) to filter malicious traffic and allow legitimate portions of the data traffic 118 into the network 102. The access point 110 enables load balancing through the tier 144(1) to distribute the data traffic 118 evenly across multiple server devices 106 (e.g., to prevent a single server from being overwhelmed). Based on the certificate relationship 302(1), the tier 144(1) supports authentication and authorization tasks performed by the access point 110 to verify the identity of the endpoint 112 and other external clients for ensuring each has the correct permissions to access network resources. The tier 144(1) further supports firewall management tasks of the access point 110 to implement firewall rules that block unauthorized access and protect the network 102 from external threats. In addition, or alternatively, the tier 144(1) implements rate limiting tasks performed by the access point 110 to improve throughput and efficiency of the data traffic 118 distributed through the network 102.

The traffic relationship 126(2) includes information to enable the access point 110 to establish a network connection through the tier 146(2) for supporting a second public facing, connection to the application instance 116(2). For example, the tier 146(2) acts as an intermediary between the tier 144(2) and 148(2). The tier 146(2) provides an intermediary entry point for external traffic into the domain of the application instance 116(2). From the tier 146(2), the endpoint 112 and the application instance 116(2) route the data traffic 118 by directing data packets to the appropriate internal server devices 106 or application services based on the communication rules 140(2) (e.g., routing protocols and policies for the data center gateway tier). The access point 110 performs encryption and decryption tasks using the certificate relationship 302(2) to secure data in transit through the tier 146(2), prior to entering the application instance 116(2) and/or decrypting incoming data from the endpoint 112. The traffic relationship 126(2) includes information to enable the access point 110 to implement Quality of Service (QoS) tasks that enable the access point 110 to prioritize the data traffic 118 through the tier 146(2) for high-reliability applications and services, including to ensure each receives adequate bandwidth and speed. Based on the traffic relationship 126(2), the access point 110 is operable to implement intrusion detection and prevention functions, including monitoring for suspicious activities and taking action to prevent potential security breaches on the network connection through the tier 146(2).

The traffic relationship 126(N) describes information to enable the access point 110 to establish a network connection through the tier 148(N) for supporting a private, application gateway tier connection to the application instance 116(N). For example, the tier 148(N) is responsible for managing the data traffic 118 within the domain of the application instance 116(N) and ensuring secure access to the application instance 116(N). From the tier 148(N), the endpoint 112 and the application instance 116(N) perform session management to maintain and manage user sessions to ensure continuous and secure access to the application instance 116(N) network application services. The tier 148(N) supports application layer security operations and tasks to implement security measure, such as web application firewalls, to protect against application-specific threats. Network segmentation occurs at the tier 148(N) to divide the network 102 into segments and limit a spread of potential security breaches and improve performance. From the tier 148(N), the access point 110 and the application instance 116(N) communicate to monitor analytics and metrics of the data traffic 118 and performance of the application instance 116(N) (e.g., for outputting notifications and alerts about anomalies or issues detected on the network 102).

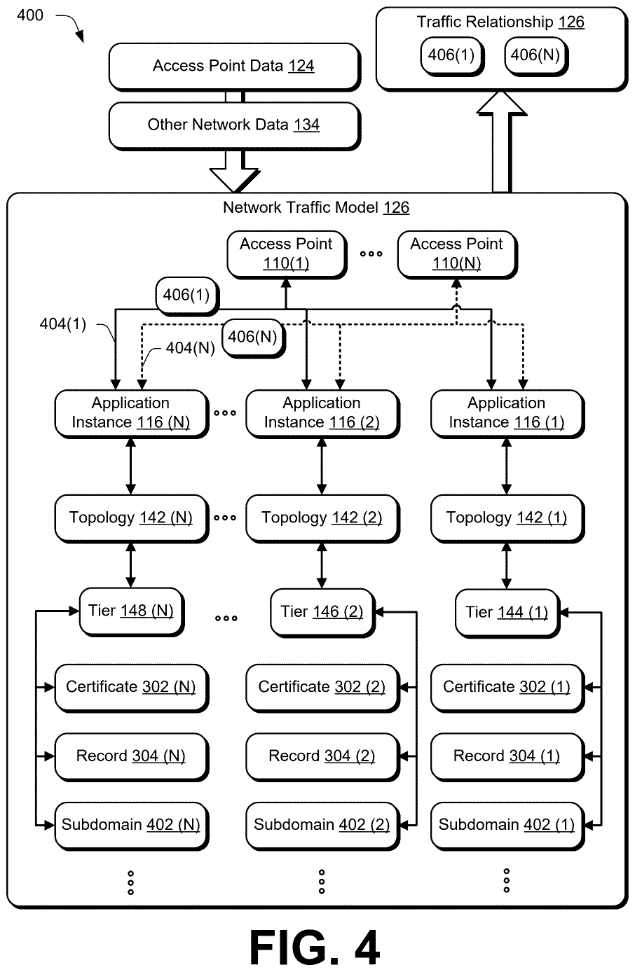

FIG. 4 depicts an example 400 of the network traffic model 128 used by the traffic management system 122 to generate the traffic relationship 126 for network connections between the access points 110(1) through 110(N) and the application instances 116(1) through 116(N). The network traffic model 128 includes an indication of a subdomain 402(1) through 402(N) associated with each different tier of the topologies 142(1) through 142(N). For example, the subdomains 402(1) through 402(N), as well as the records 304(1) through 304(N), are each obtained from a domain-subdomain relationship received from the domain name service record model 204.

A path 404(1) links a node corresponding to the access point 110(1) with nodes corresponding to each of the application instances 116(1) through 116(N). Another path 404(N) links a node corresponding to the access point 110(N) with nodes corresponding to each of the application instances 116(1) through 116(N). The information extracted from each of these paths 404(1) and 404(N) is usable by the network traffic model 128 to generate respective traffic relationships 406(1) and 406(N). Navigating the paths 404(1) and 404(N) through the network traffic model 128 produces the information used to build the traffic relationship 406(1) and 406(N), respectively. The traffic relationships 406(1) and 406(N) are included in the traffic relationship 126 output from the network traffic model 128 to the access points 110(1) through 110(N).

Advantages with the network traffic model 128 include facilitating with a hands-free certificate automation approach. The traffic relationships 126 provide a clear picture of which applications are actually using the network and domains for traffic access. This enables the access points 110 to associate lifecycle management of a certificate relationship with the lifecycle management of a network application. For example, the traffic relationships 126 are usable to ensure a smooth process for updating certificates for applications with a fine-grained control. If intended functions or traffic associated with the application instance 116 changes, developers can simply move a link or change domains associated with the application 114. As a result, the certificate relationship 302 is automatically updated by the network traffic model 128 with the updated application context.

Provisioning services executing on the network 102 also benefit from the network traffic model 128. Once the application instance 116 is created on the network 102, the network traffic model 128 automatically generates a corresponding certificate relationship 302. Conversely, if the application instance 116 is decommissioned, the certificate relationship 302 is automatically revoked. If the application instance 116(1) is decommissioned, the web, certificate, and the domain name service record model 204 used for the application instance 116(N) is not decommissioned as well.

Compliance is a big challenge for maintaining system security. Different network applications have different compliance requirements for security certificates. For example, some secure connections use end-to-end testing, which use certificates for each of the tiers from end to end to ensure compliance. In some cases, different tiers have different requirements. For example, the tier 148 and the tier 146 are mainly used for internet traffic, but sometimes a public certificate is created for specific use cases. The network traffic model 128 is flexible to consider different compliance strategies in the different tiers of the topologies of applications.

The network traffic model 128 supports various migration scenarios, such as transitioning from a hardware load balancer to a software load balancer. The underlying infrastructure of the network traffic model 128 is adaptable to allow for seamless migrations. For example, in the case of pool migrations, consistent certificates are maintained for traffic between old and new pools. From a domain name service perspective, specific IPs and device names are to be maintained. The network traffic model 128 helps ensure consistency between the old and the new pools, especially in terms of certificates, facilitating smooth traffic flow. Additionally, network traffic model 128 is adaptable for other use cases, such as public API audits, by establishing correlations between domain name service layers, certificates, and access points.

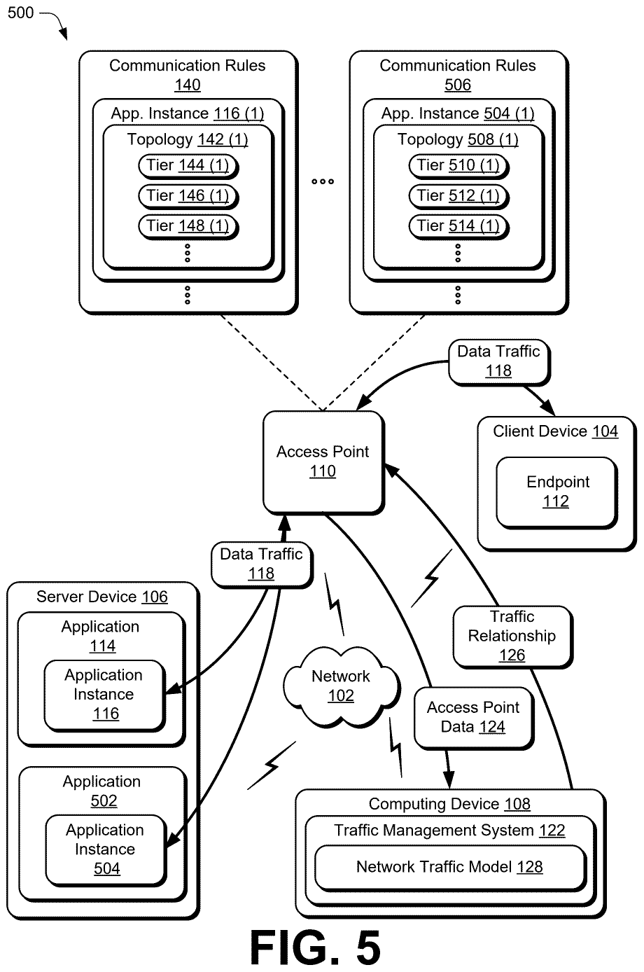

FIG. 5 is an illustration of an environment 500 in an example implementation that is operable to employ the traffic management system 122, including the network traffic model 128 for modeling the data traffic 118 for network application services supported through execution of multiple applications, including the application 114 and at least one additional application 502. One or more application instances 504 of the additional application 502 execute on the server device 106 to support network application services accessed by the endpoint 112.

The environment 500 is a multiple application example of the environment 100. The network traffic model 128 is adaptable with changes to the network 102 and how multiple applications, e.g., the application 114 and the application 502, are implemented on the server device 106 (e.g., same or different processor) or different server devices connected to the network 102. For example, the network traffic model 128 updates the traffic relationship 126 to replace the application instance 116(2) with an application instance 504(1) or to remove the application instance 116(2) without replacing. The traffic relationship 126 is updated, for example, after the application 114 and/or the application instance 116(2) is decommissioned from the network 102 over a period of time.

In at least one implementation, the network application services requested by the endpoint 112 based on the data traffic 118 include one or more first requests for services that utilize the application 114, and one or more second requests for services that utilize the application 502. An application instance 116(1), for example, responds to the first requests independent from an application instance 504(1), and independent from a response from the application instance 504(1) to the second requests.

In at least one other example, the network application services requested by the endpoint 112 by communicating the data traffic 118 include requests for services that utilize the application 114 in combination with the application 502. The application instance 116(1) and the application instance 504(1) are operable to execute in a collaborative manner, for instance, to implement related network application services.

The network traffic model 128 receives the access point data 124, which in this example is indicative of the conditions of the network 102 and the data traffic 118 being exchanged between the endpoint 112 and the application instances 116(1) and 504(1). Based on the access point data 124, the network traffic model 128 derives the traffic relationship 126 to describe to the access point 110 the communication rules 140 for communicating with the application instance 116(1), in addition to communication rules 506 for communicating with the application instance 504(1).

As illustrated, the communication rules 506 define aspects of a network topology 508(1) linking the application instance 504(2) to the network 102. The topology 508(1), for example, includes multiple different tiers 510(1), 512(1), and 514(1), each with logical and/or physical attributes defined by the traffic relationship 126.

In one or more scenarios, the application 114 and the application 502 are executed within a common application stack (e.g., using Java web to node Java script) and overtime the application 502 moves to a different application stack than the application 114. The network traffic model 128 is operable to update the traffic relationship 126 to redefine the communication rules 506 originally established for the common application stack to reconfigure the access point 110 to correctly manage the data traffic 118 now moving between two different application stacks on the server device 106 or different server devices. The traffic relationship 126 configures the access point 110 to maintain aspects of the traffic relationship 126 prior to the migration without compromising overall integrity. The traffic relationship 126 is updated to describe changes to the traffic migration or routing that are specific to the topology 508(1) while keeping the topology 142(1) information the same for the application instance 116(1).

Having considered example systems and techniques for generating access point certificates, consider now example procedures to illustrate aspects of the techniques described herein.

### Example Procedures

The following discussion describes techniques that are configured to be implemented utilizing the previously described systems and devices. In general, functionality, features, and concepts described in relation to the examples above and below are employable in the context of steps of an example procedure described in this section. Further, functionality, features, and concepts described in relation to different figures and examples in this document are interchangeable among one another and are not limited to implementation in the context of a particular figure or step of the procedure. Moreover, blocks associated with different corresponding figures herein are configured to be applied together and/or combined in different ways.

Thus, individual functionality, features, and concepts described herein in relation to different example environments, devices, components, figures, and procedural steps are useable in any suitable combinations and are not limited to the combinations represented by the enumerated examples in this description. Aspects of each of the procedural steps are configured for implementation in hardware, firmware, software, or a combination thereof. The procedural steps are shown as a set of blocks that specify operations performed by one or more devices and are not necessarily limited to the orders shown for performing the operations by the respective blocks. In portions of the following discussion, reference is made to FIGS. 1-5.

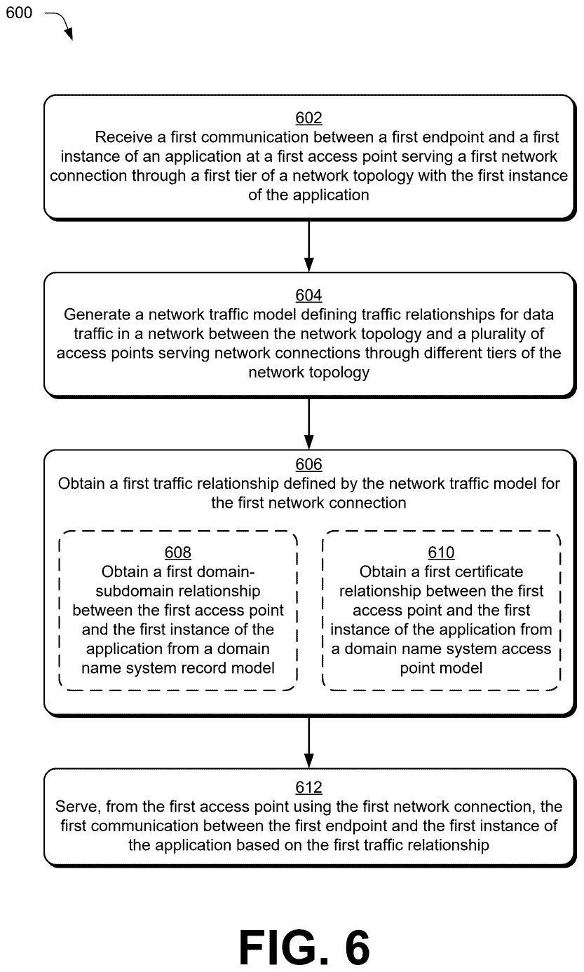

FIG. 6 depicts a procedure 600 in an example implementation in which a traffic relationship is defined by the traffic management system 122 to control data communication via the access point 110. The procedure 600 starts with receiving a first communication between a first endpoint and a first instance of an application at a first access point serving a first network connection through a first tier of a network topology with the first instance of the application (block 602). The access point 110, for instance, receives the data traffic 118 when managing communications between the application instance 116 and the endpoint 112. From the data traffic 118, the access point 110 prepares to serve the communications 202.

Next, the procedure 600 includes generating a network traffic model defining traffic relationships for data traffic in a network between the network topology and a plurality of access points serving network connections through different tiers of the network topology (block 604). The traffic management system 122, for example, generates the network traffic model 128 to define the traffic relationship 126 based on the access point data 124 obtained from the listener 120 of the access point 110.

The procedure 600 continues with obtaining a first traffic relationship defined by the network traffic model for the first network connection (block 606). The traffic management system 122 outputs the traffic relationship 126 defined by the model to the listener 120. Within the traffic relationship 126, the network traffic model 128 includes the communication rules 140 and other communication protocol information to enable the access point 110 to serve the communications 202 through the network connections shared by the application instance 116 with the network 102.

Optionally, the procedure 600 includes obtaining a first domain-subdomain relationship between the first access point and the first instance of the application from a domain name system record model (block 608). For example, the network traffic model 128 is configured to base the traffic relationship 126 at least partially on a domain name service record 304 or a domain-subdomain relationship 402 obtained from the domain name service record model 204.

Optionally, the procedure 600 includes obtaining a first certificate relationship between the first access point and the first instance of the application from a domain name system access point model (block 610). The network traffic model 128, for instance, is configured to base the traffic relationship 126 at least partially on a certificate relationship 302 obtained from the domain name service access point model 206.

The procedure 600 ends in the illustrated example by serving, from the first access point using the first network connection, the first communication between the first endpoint and the first instance of the application based on the first traffic relationship (block 612). The access point 110, for instance, applies the information described in the traffic relationship 126 received from the traffic management system 122 to serve the communications 202 on a network connection established linking the endpoint 112 via the access point 110 through the network topology to the application instance 116. The serving by the access point 110 includes using the communication rules 140 (e.g., first routing rules of a first tier) to transfer the communications 202 between the endpoint 112 and the application instance 116.

Having described example procedures in accordance with one or more implementations, consider now an example system and device to implement the various techniques described herein.

### Example System and Device

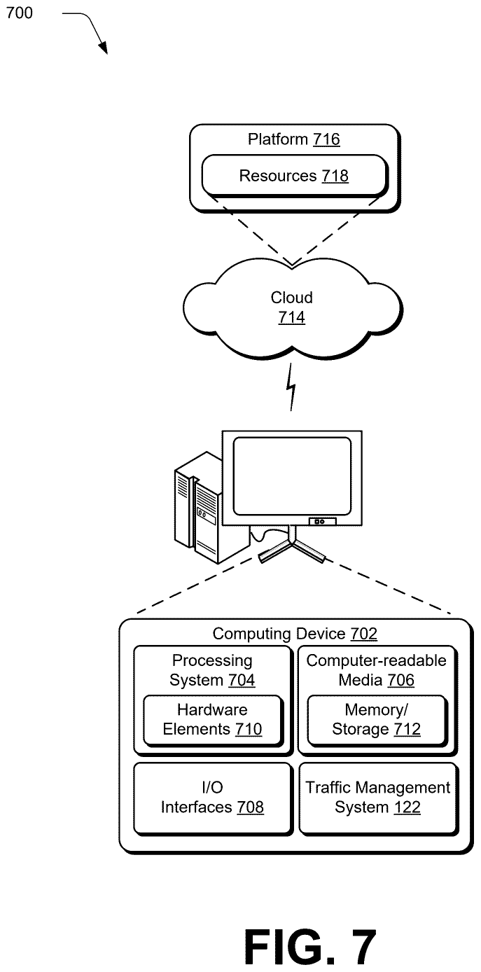

FIG. 7 illustrates an example system 700 that includes an example computing device 702, which is representative of one or more computing systems and/or devices that implement the various techniques described herein. This is illustrated through inclusion of the traffic management system 122. The computing device 702 is configured, for example, as a service provider server, as a device associated with a client (e.g., a client device), as an on-chip system, and/or as any other suitable computing device or computing system.

The example computing device 702 as illustrated includes a processing system 704, one or more computer-readable media 706, and one or more I/O interface 708 that are communicatively coupled, one to another. Although not shown, the computing device 702 is further configured to include a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that are configurable as processors, functional blocks, and so forth. For instance, hardware element 710 is implemented in hardware as an application specific integrated circuit or other logic device formed using one or more semiconductors. The hardware elements 710 are not limited by the materials from which they are formed, or the processing mechanisms employed therein. For example, processors are alternatively or additionally comprised of semiconductor(s) and/or transistors (e.g., electronic integrated circuits (ICs)). In such a context, processor-executable instructions are electronically executable instructions.

The computer-readable storage media 706 is illustrated as including memory/storage 712. The memory/storage 712 represents memory/storage capacity associated with one or more computer-readable media. The memory/storage 712 is representative of volatile media (such as random-access memory (RAM)) and/or nonvolatile media (such as read only memory (ROM), Flash memory, optical disks, magnetic disks, and so forth). The memory/storage 712 is configured to include fixed media (e.g., RAM, ROM, a fixed hard drive, and so on) as well as removable media (e.g., Flash memory, a removable hard drive, an optical disc, and so forth). In various implementations, the computer-readable media 706 is configured in a variety of other ways as further described below.

Input/output interface(s) 708 are representative of functionality to allow a user to enter commands and information to computing device 702 and allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., a device configured to employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is representative of a variety of hardware configurations as further described below to support user interaction.

Various techniques are described herein in the general context of software, hardware elements, or program modules. Generally, such modules include routines, programs, objects, elements, components, data structures, and so forth that perform particular tasks or implement particular data types. The terms “module,” “functionality,” and “component” as used herein generally represent software, firmware, hardware, or a combination thereof. The features of the techniques described herein are platform-independent, meaning that the techniques are configured for implementation on a variety of commercial computing platforms having a variety of processors.

An implementation of the described modules and techniques are stored on or transmitted across some form of computer-readable media. The computer-readable media include a variety of media that is accessible by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 702, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employed in some embodiments to implement at least some aspects of the techniques described herein, such as to perform one or more instructions. Hardware, in various implementations, includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are employed to implement various techniques described herein. Accordingly, software, hardware, or executable modules are implemented as one or more instructions and/or logic embodied on some form of computer-readable storage media and/or by one or more hardware elements 710. The computing device 702 is configured to implement instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supported by various configurations of the computing device 702 and are not limited to the specific examples of the techniques described herein. This functionality is further configured to be implemented at least in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that is utilized while computer processing is executed on servers that are remote from the computing device 702. Resources 718 also include services provided over the Internet and/or through a subscriber network, such as a cellular or Wi-Fi network.

The platform 716 is configured to abstract resources and functions to connect the computing device 702 with other computing devices. The platform 716 is further configured to abstract scaling of resources to provide a corresponding level of scale to encountered demand for the resources 718 that are implemented via the platform 716. Accordingly, in an interconnected device embodiment, implementation of functionality described herein is configured for distribution throughout the system 700. For example, in some configurations the functionality is implemented in part on the computing device 702 as well as via the platform 716 that abstracts the functionality of the cloud 714.

### Conclusion

Although the invention has been described in language specific to structural features and/or methodological acts, the invention defined in the appended claims is not necessarily limited to the specific features or acts described. Rather, the specific features and acts are disclosed as example forms of implementing the claimed invention.

What is claimed is:

1. A method comprising:
generating a network traffic model defining traffic relationships for data traffic in a network between a network topology of an application and a plurality of access points serving network connections through different tiers of the network topology, whereby at least one instance of the application is based in part on domain-subdomain relationships obtained from a domain name system record model for communicating on the network;
receiving a first communication between a first endpoint and a first instance of the application at a first access point serving a first network connection through a first tier of the network topology with the first instance of the application; and
serving, from the first access point using the first network connection, the first communication between the first endpoint and the first instance of the application based on a first traffic relationship defined by the network traffic model for the first network connection.

2. The method of claim 1, further including:
obtaining a first domain-subdomain relationship between the first access point and the first instance of the application from the domain name system record model used by the network traffic model to at least partially define the first traffic relationship for the first network connection.

3. The method of claim 1, wherein the network traffic model further defines the traffic relationships based in part on certificate relationships obtained from a domain name system access point model for communicating on the network.

4. The method of claim 3, further including:
obtaining a first certificate relationship between the first access point and the first instance of the application from the domain name system access point model used by the network traffic model to at least partially define the first traffic relationship for the first network connection.

5. The method of claim 1, wherein the different tiers each adopt different corresponding routing rules, and the first traffic relationship includes first routing rules defined by the network traffic model for the first tier of the network topology for the first instance of the application.

6. The method of claim 5, wherein the serving includes using the first routing rules to transfer the first communication between the first endpoint and the first instance of the application.

7. The method of claim 5, wherein the different tiers include a domain name service tier and at least one other tier.

8. The method of claim 1, wherein the application is a first application within a domain, and the first endpoint includes a second application within the domain.

9. The method of claim 1, wherein the application is a first application within a domain, and the first endpoint includes a second application outside the domain.

10. The method of claim 1, wherein the application implements one or more services on behalf of the first endpoint based on the first communication.

11. The method of claim 1, wherein the access points include at least one of virtual internet protocol (VIP) access points, secure access points, or unsecure access points.

12. An access point device comprising at least one processor configured to:
access a network traffic model that defines traffic relationships for data traffic in a network between a network topology of an application and a plurality of different access points serving network connections through different physical or logical tiers of the network topology, whereby at least one instance of the application being based in part on domain-subdomain relationships obtained from a domain name system record model for communicating on the network;
receive a first communication between a first endpoint and a first instance of the application; and
responsive to receiving the first communication, serve the first communication on a first network connection through a first tier of the network topology with the first instance of the application based on a first traffic relationship defined by the network traffic model for the first network connection.

13. The access point device of claim 12, wherein the network traffic model further defines the traffic relationships based in part on certificate relationships obtained from a domain name system access point model for communicating on the network.

14. The access point device of claim 12, wherein the network traffic model includes a graph representing each access point and each application instance as a different corresponding node, and further representing each network connection as a different corresponding path between a corresponding pair of nodes in the graph.

15. The access point device of claim 12, wherein the different physical or logical tiers include a domain name service tier.

16. The access point device of claim 12, wherein the different physical or logical tiers each adopt different corresponding routing rules, and the first traffic relationship includes first routing rules defined by the network traffic model for the first tier of the network topology with the first instance of the application.

17. The access point device of claim 16, wherein the access point device uses the first routing rules when serving the first communication on the first network connection.

18. A computing device comprising:
a computer-readable storage medium that stores instructions; and
a processor that executes the instructions to perform operations to implement an access point, the operations including:
accessing a network traffic model defining traffic relationships for data traffic in a network between corresponding network topologies of a plurality of applications and at least one access point serving network connections through different tiers of the network topologies with at least one instance of each of the plurality of applications;
serving, from the access point, a first communication between an endpoint and a first instance of a first application using a first network connection through a first tier of a first network topology with the first instance of the first application based on a first traffic relationship defined by the network traffic model for the first network connection; and
serving, from the access point, a second communication between the endpoint and a second instance of a second application using a second network connection through a second tier of a second network topology with the second instance of the second application based on a second traffic relationship defined by the network traffic model for the second network connection.

19. The computing device of claim 18, wherein the network traffic model further defines the traffic relationships based in part on at least one of:
domain-subdomain relationships obtained from a domain name system record model for communicating on the network; or
certificate relationships obtained from a domain name system access point model for communicating on the network.

20. The computing device of claim 18, wherein:
the first traffic relationship includes first routing rules defined by the network traffic model for the first tier of the network topology with the first instance of the application, and the access point serves the first communication between the endpoint and the first instance of the application by adopting the first routing rules; and
the second traffic relationship includes second routing rules defined by the network traffic model for the second tier of the second network topology with the second instance of the application, and the access point serves the second communication between the endpoint and the second instance of the application by adopting the second routing rules.
